(19) United States
(12) Patent Application Publication
(10) Pub. No.: US 2013/0153763 A1
(43) Pub. Date: Jun. 20, 2013

(54) NANOPOROUS VACUUM PUMP

(71) Applicant: Andrew Saint, Fitzroy (AU)

(72) Inventor: Andrew Saint, Fitzroy (AU)

(73) Assignee: GBC SCIENTIFIC EQUIPMENT PTY. LTD., Braeside (AU)

(21) Appl. No.: 13/704,959

(22) PCT Filed: Jun. 17, 2011
(86) PCT No.: PCT/AU2011/000729

§ 371 Date: Feb. 27, 2013

(30) Foreign Application Priority Data
Jun. 18, 2010 (AU) 2010902670

(51) Int. Cl. F04B 37/10; H01J 49/10; H01J 49/02; H01J 27/02

(52) U.S. Cl. CPC F04B 37/10; H01J 27/02; H01J 49/10; H01J 49/02
USPC 250/288; 417/49; 250/423 R; 250/489

(57) ABSTRACT

The invention provides an element (12), comprising: a nanoporous insulating film (20) (such as a thin nanoporous diamond film) and first and second conducting layers (18a, 18b) on first and second opposed sides respectively of the film (20). Also provided are a vacuum pump (10), an ion source (80) and an ion trap (98), each comprising such an element (12).

### RELATED APPLICATION

This application is based on and claims the benefit of the filing and priority dates of AU application no. 2010902670 filed 18 Jun. 2010, the content of which as filed is incorporated herein by reference in its entirety.

### FIELD OF THE INVENTION

The present invention relates to a nanoporous vacuum pump, based on a nanoporous insulating (e.g. diamond) film, of particular but by no means exclusive use in providing a vacuum pump with a small pump profile that is compatible with hand-held devices such as gas chromatography-mass spectrometers (GC-MSs) and other mass spectrometers, and other applications of the insulating film including in providing an ion source and an ion trap.

### BACKGROUND OF THE INVENTION

One existing vacuum pump employs a thin film of continuously deposited titanium, in which the titanium—being highly reactive—reacts with and captures residual gas in the pump chamber.

Naturally occurring nanoporous zeolite has been proposed as the active element of a miniature Knudsen pump.

Frank Hartley and Isik Kanik (Proceedings of SPIE Vol. 4936 (2002)) have fabricated Soft Ionising Membranes (SIMs) in silicon nitride material, for use in ionising atoms or molecules in the gas phase by field ionisation.

### SUMMARY OF THE INVENTION

In broad terms, the present invention provides an element, comprising:
a nanoporous insulating film; and
first and second conducting layers (or coatings) on first and second opposed sides respectively of the film.

In one embodiment, the insulating film comprises a thin nanoporous diamond film.

The first and second conducting layers may comprise metallic layers.

In another embodiment, the first and second conducting layers comprise evaporatively deposited layers.

The first and second conducting layers may comprise molybdenum or gold.

In a first broad aspect, the present invention provides a pumping element, comprising:
a nanoporous insulating film; and
first and second conducting layers on first and second opposed sides respectively of the film.

Thus, the pumping element has the configuration of a perforated capacitor.

In one embodiment, the insulating film comprises a thin nanoporous diamond film.

In one embodiment, the first and second conducting layers comprise metallic coatings (such as of Mo or Au).

In an embodiment, the first and second conducting layers comprise evaporatively deposited coatings.

In a second broad aspect, the present invention provides a pump, comprising:
a pumping element comprising: a nanoporous insulating film comprising a plurality of nanopores, and first and second conducting layers on first and second opposed sides respectively of said film; and
a power supply configured to maintain a potential difference between the first and second conducting layers that produces a field ionizing electric field;
wherein said pumping element supports a difference in gas pressure on said first and second conducting layers and supports field ionization by the electric field, and said electric field ionizes gas atoms or molecules in a proximity of said first conducting layer, transports said gas atoms or molecules once ionised through said first conducting layer into said nanopores, along said nanopores and through said second conducting layer.

In one embodiment, the difference in gas pressure is one atmosphere.

In a particular embodiment, the electric field is approximately 10 MV/cm.

In one embodiment, the insulating film comprises a thin nanoporous diamond film. In another embodiment, the insulating film comprises a thin nanoporous silicon nitride film.

The first and second conducting layers may comprise metallic layers, such as evaporatively deposited layers.

The first and second conducting layers may comprise molybdenum or gold.

In a certain embodiment, the power supply is configured to maintain the first conducting layer at a negative potential relative to the second conducting layer. This potential may be relatively low (of, for example, −300 to −500 V).

In one embodiment, the pump is adapted to operate with the first conducting layer at a negative potential (of, for example, −300 to −500 V) and the second conducting layer earthed.

In a third broad aspect, the present invention provides a vacuum chamber, comprising a pump as described above.

In a fourth broad aspect, the present invention provides a scientific instrument (such as a mass spectrometer), comprising a pump as described above.

In one embodiment, the scientific instrument is a hand-held mass spectrometer.

In a fifth broad aspect, the present invention provides a method of pumping, comprising employing a pump as described above.

In a sixth broad aspect, the present invention provides a method of evacuating a scientific instrument (such as a hand-held or other mass spectrometer), comprising employing a pump as described above.

In a seventh broad aspect, the invention provides an ion source, comprising a pump as described above. The insulating film may comprise a thin nanoporous diamond film.

Diamond is physically strong (which is especially important in embodiments in which the insulating film must support atmospheric pressure), and has a high dielectric strength (˜1000 kV/mm), which facilitates the generation of high electric fields for field ionisation. In other embodiments, silicon nitride may be used; silicon nitride also has a high dielectric strength but lacks the physical strength of diamond so may not be appropriate where such strength is required. In still other embodiment, the insulating film may be alumina (Al₂O₃); alumina, though having good physical strength, may have an inadequate dielectric strength for some applications.

The power supply may be configured to maintain the first conducting layer at a negative voltage of the order of 100s of volts relative to the second conducting layer.

In an eighth broad aspect, the invention provides an ion trap, comprising:
an ion-trap element comprising: a nanoporous insulating film comprising a plurality of nanopores, and first and second conducting layers on first and second opposed sides respectively of said film; and
a RF power supply coupled to said first and second conducting layers to provide a potential difference between said first and second conducting layers;
wherein the nanoporous insulating film is doped so as to have a conducting region between the opposed sides and respective more insulating regions between the conducting region and the respective opposed sides, and a RF field applied to the first and second conducting layers by the RF power supply imposes a potential on the conducting region, whereby the central region and the RF field act as an ion trap.

In one embodiment, the RF power supply has an operating frequency range between 1 MHz and 100 MHz.

In a particular embodiment, the potential difference is between 30 V peak to peak and 300 V peak to peak.

In a ninth broad aspect, the invention provides a mass spectrometer, comprising an ion source as described above.

In a tenth broad aspect, the invention provides a mass spectrometer, comprising an ion trap as described above.

Indeed, the invention also provides a scientific instrument (such as a mass spectrometer) comprising one or more of the pump, ion source and ion trap described above.

In an eleventh broad aspect, the invention provides a method of providing ions, comprising employing the ion source described above.

In a twelfth broad aspect, the invention provides a method of trapping ions, comprising employing the ion trap described above.

It should be noted that any of the various features of each of the above aspects of the invention can be combined as suitable and desired.

### BRIEF DESCRIPTION OF THE DRAWING

In order that the invention may be more clearly ascertained, embodiments will now be described, by way of example, with reference to the accompanying drawing, in which:

FIG. 1 is a schematic view of a vacuum pump according to an embodiment of the present invention;

FIG. 2 is a schematic cross-sectional view of the pumping element of the vacuum pump of FIG. 1;

FIGS. 3A and 3B are photographs of a diamond film suitable for use in the vacuum pump of FIG. 1;

FIG. 4 is a schematic, functional view of the pumping element of the vacuum pump of FIG. 1;

FIG. 5A is a schematic, operational view of a detail of the pumping element of the vacuum pump of FIG. 1;

FIG. 5B is a further schematic, operational view of a detail the pumping element of the vacuum pump of FIG. 1;

FIG. 6 is a schematic view of a vacuum chamber provided with a vacuum pump, according to an embodiment of the present invention;

FIG. 7 is another schematic view of the vacuum chamber of FIG. 6, illustrating the operation of the vacuum pump of FIG. 1 and of the vacuum chamber of FIG. 6;

FIG. 8 is a schematic view an ion source according to an embodiment of the present invention;

FIG. 9 is a schematic cross-sectional detail view of the ionizing element of the ion source of FIG. 8;

FIG. 10 is a schematic view an ion trap according to an embodiment of the present invention;

FIGS. 11A and 11B are, respectively, a schematic cross-sectional detail view of the ion trap of FIG. 10 and a schematic plot of dopant concentration as a function of distance across the diamond film of the ion trap of FIG. 10;

FIG. 12 shows a structural detail and an electrical equivalence circuit of the ion trap of FIG. 10; and

FIG. 13 is a schematic view of a miniature mass spectrometer according to another embodiment of the present invention.

### DETAILED DESCRIPTION

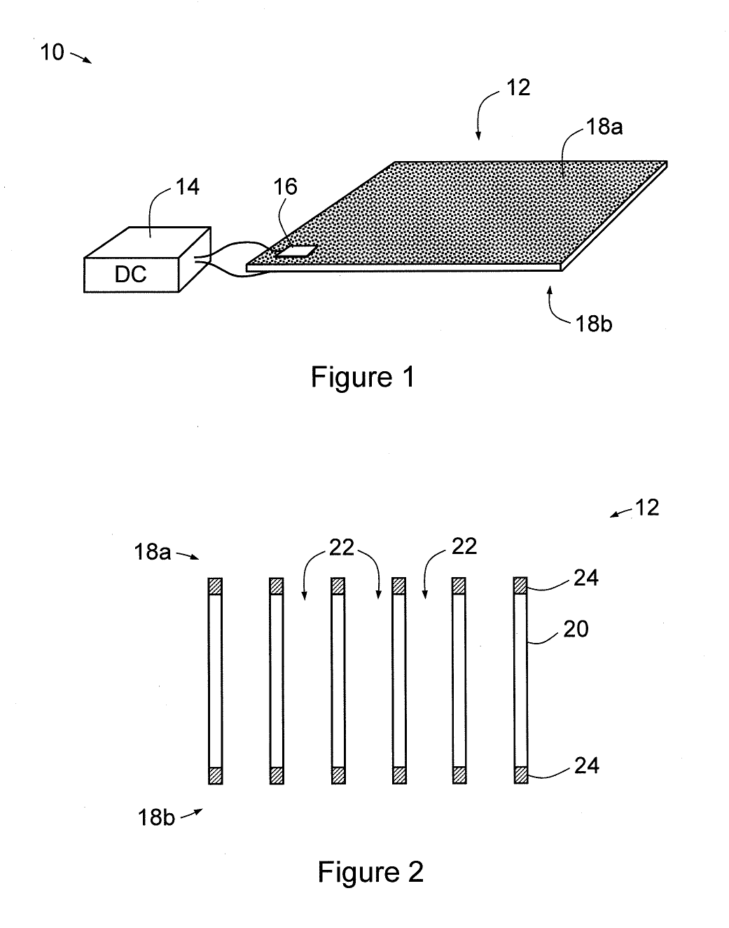

FIG. 1 is a schematic view of a vacuum pump 10 according to an embodiment of the present invention. Pump 10 comprises a generally planar pumping element 12, a DC power supply 14, a first electrical connector 16 located on a first face 18a of pumping element 12 (the upper face in this view) and a second electrical connector (not shown) located on a second face 18b (the lower face in this view), opposite first face 18a, of pumping element 12. The electrical outputs of DC power supply 14 are electrically connected to the first and second electrical connectors respectively, to hold first face 18a at a negative voltage (in this embodiment of −300 V) relative to second face 18b.

FIG. 2 is a schematic cross-sectional view of pumping element 12. Pumping element 12 comprises an insulating film in the form of nanoporous diamond film 20, which has nanopores 22, and a conducting coating 24 applied to diamond film 20 and constituting first and second faces 18a, 18b. In this embodiment, conducting coating 24 is of either Mo or Au. Molybdenum has the advantage of have a similar thermal expansion coefficient to that of diamond; gold has the advantage of high conductivity. In this embodiment, conducting coating 24 is deposited onto diamond film 20 by magnetron evaporation.

The first and second electrical connectors, though not shown in this view, are thus in electrical contact with coating 24. Coating 24 does not significantly block nanopores 22.

It will be appreciated that, in some applications, vacuum pump 10 would be employed with a suitable backing pump.

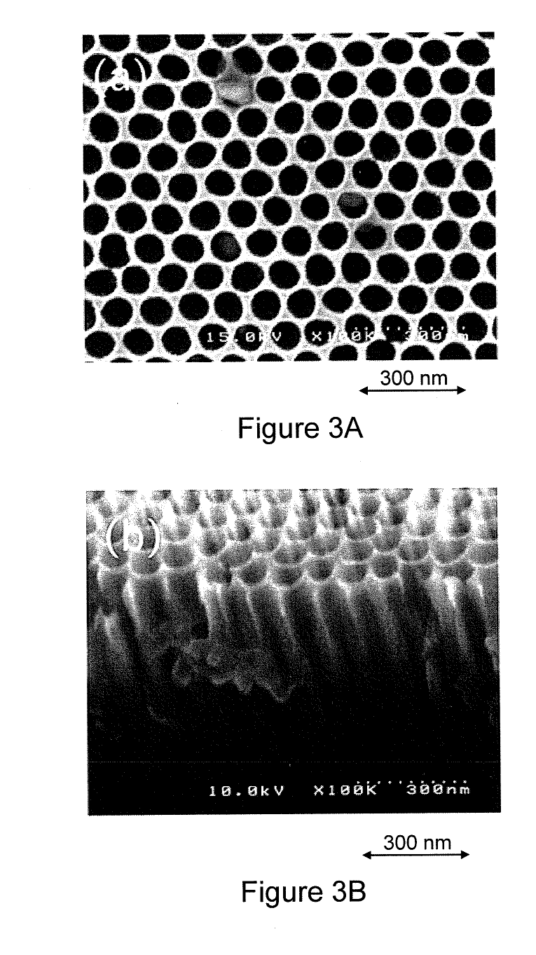

A diamond film is advantageously used in this embodiment because of diamond's high electrical break-down potential (approximately 10 MV/cm) and high tensile strength (required to support 1 atmosphere over a fairly large area). FIGS. 3A and 3B are photographs of a suitable nanoporous diamond film, made by masking using a self-aligning alumina nanofilm. FIG. 3A is a photograph of the diamond film viewed face-on, FIG. 3B is a photograph of the diamond film viewed obliquely.

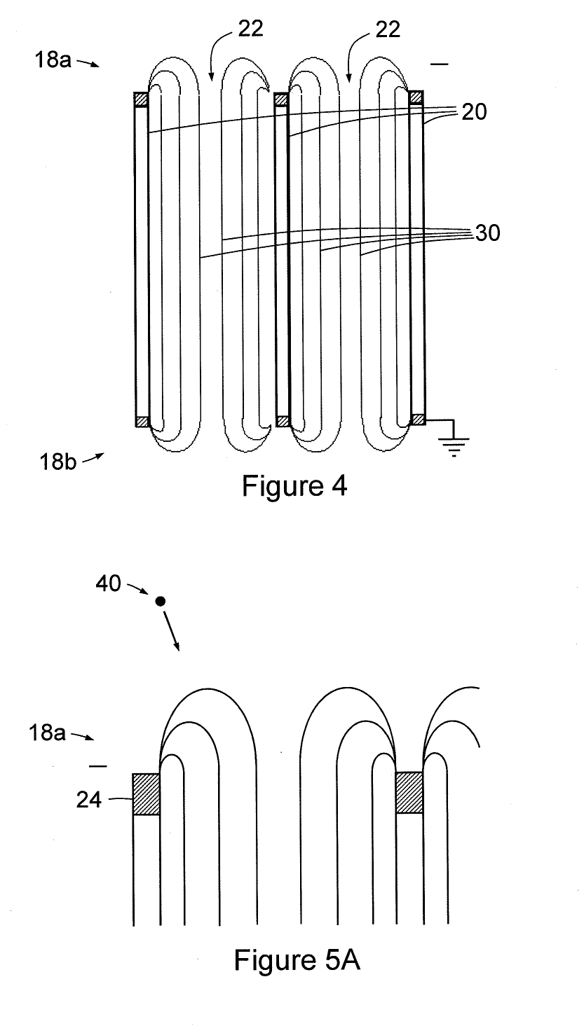

Pumping element 12 may thus be viewed as essentially a perforated capacitor, in which an insulator in the form of diamond film 20 is sandwiched between two perforated conducting plates (in the form of respective portions of coating 24). When a modest voltage is applied across those ‘plates’ with DC power supply 14, an electric field is established between the two plates. The low polarizability of diamond allows the support of very high electric fields. This is depicted schematically in FIG. 4, showing a portion of pumping element 12 and electrical fields lines 30 generated as a result of the potential difference (due to DC power supply 14) between first or upper face 18a and second or lower face 18b. It will be seen that the field lines are, within nanopores 22, generally parallel to nanopores 22.

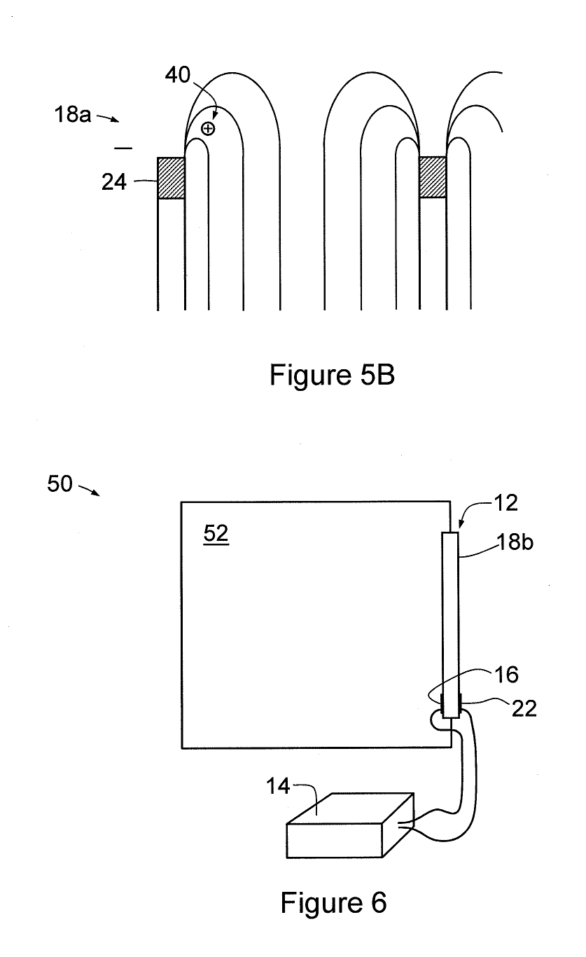

FIGS. 5A and 5B are schematic, functional views of a detail of pumping element 12 in use. Referring to FIG. 5A, when a gas atom or molecule approaches the negative surface of pumping element 12 (i.e. first face 18a), it will become polarized and attracted to the edge of that portion of conducting coating 24 that is at the openings of nanopores 22 at first face 18a. The polarized gas molecule/atom will be attracted to the region of highest electric field, where the electric field is high enough for field ionization of the gas molecule/atom. Once ionized (see FIG. 5B), the now positive gas ion is accelerated down one of nanopores 22 and out the other side (i.e. second face 18b) of pumping element 12, accelerated away by second face 18b which is earthed.

SIMION simulations have been conducted and, SIMION cannot simulate the presence of an insulator, they appear to indicate that with a potential difference of −300 V, the ions will pass out of the far end (i.e. at second face 18b) of the nanopores 22.

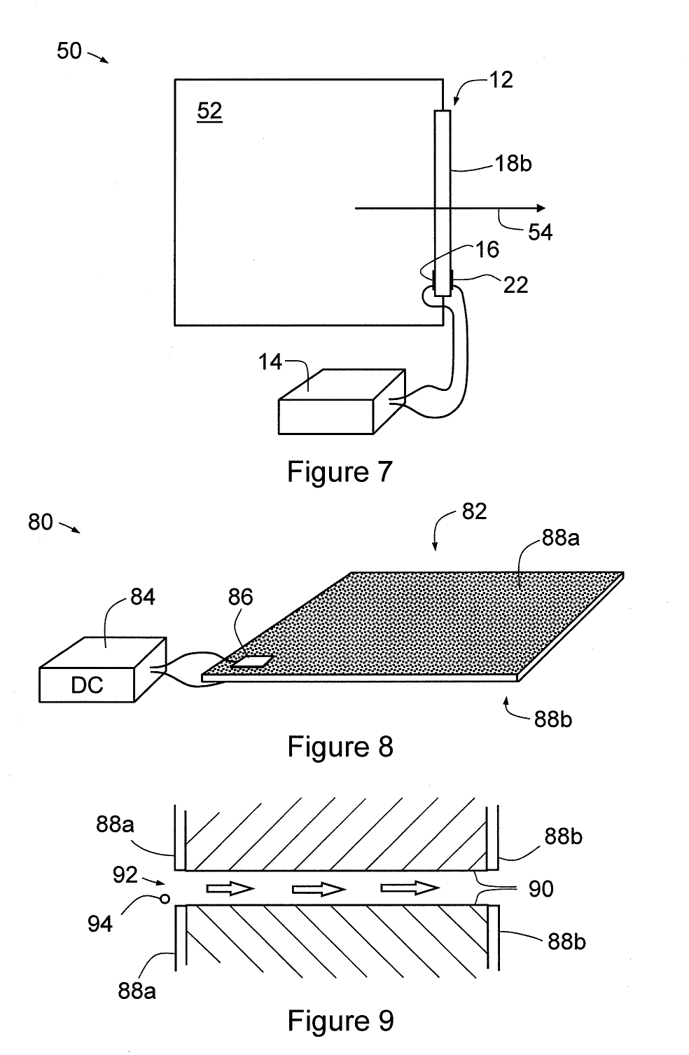

If such a vacuum pump 10 is provided in a vacuum chamber, mounted at the interface between the interior of the chamber and the atmosphere, there will be a net transfer of ions (i.e. gas) from the chamber out of the vacuum system, leading to a net pumping effect. FIG. 6 is a schematic view of a vacuum chamber 50 according to an embodiment of the present invention, provided with a vacuum pump comparable to vacuum pump 10 of FIG. 1 (and hence including like features). FIG. 7 is another schematic view of vacuum chamber 50 of FIG. 6, illustrating its operation and that of vacuum pump 10 of FIG. 1. When DC power supply 14 is in operation, gas ions in the interior 52 of vacuum chamber 50 will be drawn through pumping element 12 an exit in direction 54.

If ions back-stream along nanopores 22, they will either be ionized by electron bombardment from the field emission electrons emitted from the negative side of pumping element 12 or they will be ionized back at the earthed end of the film and directed back out of the chamber by the E field between the two sides of the film.

The result is a very thin film vacuum pump that is driven by relatively low voltages (e.g. 300 to 500 V) that can readily be incorporated into a hand-held mass spectrometer.

According to another embodiment, a device comparable to the vacuum pump of FIG. 1 can be employed as a Soft Ionising Membranes (SIM) device, for ionizing atoms and molecules. Diamond has the advantage of allowing large electric fields to be used to effect field ionisation so, according to this embodiment, an ion source is provided that is comparable in construction to vacuum pump 10 of FIG. 1, comprising a nanoporous thin diamond film (a few microns thick) with metallic contact surfaces on either face of the diamond film. This allows the use of low voltages and lower power demands, which are desirable in miniaturised instrumentation.

FIG. 8 is a schematic view an ion source 80 according to this embodiment. As will be apparent to the skilled person, ion source 80 is identical in construction in many respects with vacuum pump 10 of FIG. 1. Thus, ion source 80 comprises a generally planar ionizing element 82 which has nanopores, a DC power supply 84, a first electrical connector 86 located on a first conducting face 88a of ionizing element 82 (the upper face in this view) and a second electrical connector (not shown) located on a second conducting face 88b (the lower face in this view), opposite first face 88a, of ionizing element 82. The electrical outputs of DC power supply 84 are electrically connected to the first and second electrical connectors respectively, to hold first face 88a at a negative voltage (of the order of 100s of volts, and in this embodiment of −300 V) relative to second face 88b. Such voltages are higher than existing. SIM devices, but are still manageable, both from the generation and breakdown perspectives.

FIG. 9 is a schematic cross-sectional detail view of ionizing element 82. Ionizing element 82 is approximately 5 μm thick, and comprises a nanoporous diamond film 90 with front and rear conducting coatings constituting first and second faces 88a, 88b, respectively. In this embodiment, first and second faces 88a, 88b are of gold, but in other embodiments may be of other conducting materials (such as Mo). Each nanopore 92 of ionizing element 82 has a diameter of approximately 50 nm.

Ionizing element 82 is thus thicker than existing SIM devices, but provides soft ion ionisation as well as collimation (which is important, as orthogonal time-of-flight mass spectrometry requires a beam that is highly parallel in order to optimise resolution and reduce which has been termed ‘turn-around’ time). An atom or molecule 94 is ionized once in the proximity of the electrical field of ionizing element 82 and the resulting ion, owing to its charge, is drawn into and along—and ultimately emerges from—a nanopore 92. The large aspect ratio of ionizing element 82 causes the emerging ions to be collimated.

According to still another embodiment, the present invention provides an ion-trap, comprising individual nano-scale ion traps in a metalized, doped diamond film. In this embodiment, the ion-trap is produced by growing a doped diamond film, in which the dopant level is controlled so that the film once grown is conducting at its centre and gradually becomes more insulating toward its faces.

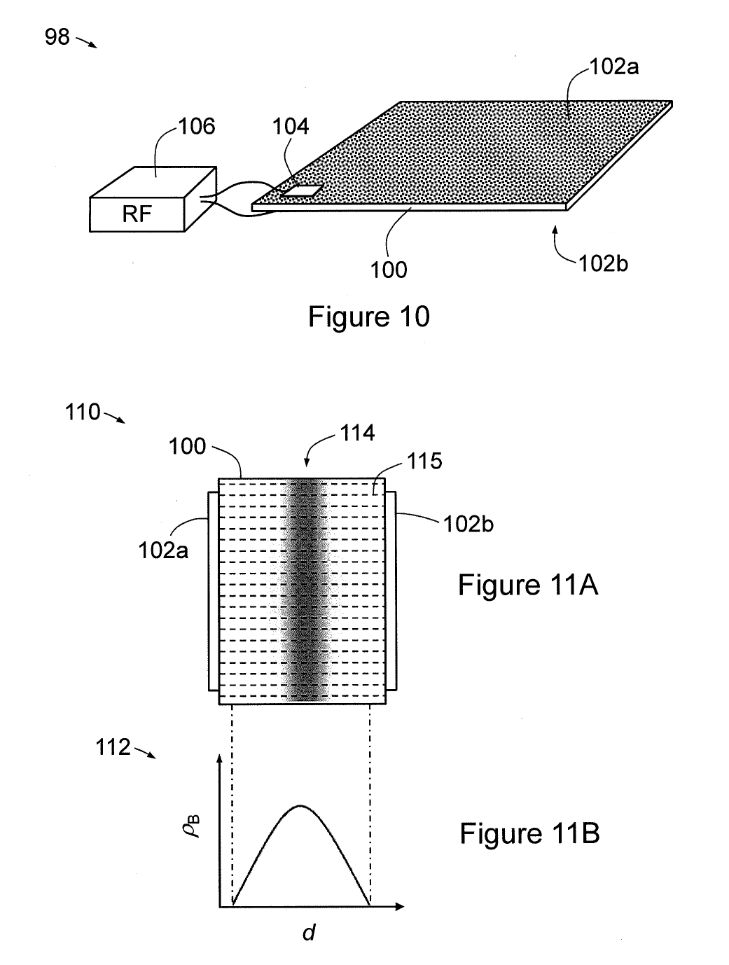

To produce a suitable film, the diamond film is grown then etched to produce a nanoporous structure, then metalized (in this embodiment with gold) on both sides to produce the electrical contacts for the application of RF power. The result is illustrated schematically in FIG. 10, which is a schematic view of an ion-trap 96 according to this embodiment. In this embodiment, the dopant is boron, but other dopants may be used with diamond (such as nitrogen) and, in embodiments in which the insulating film is other than diamond, other dopants will be used as appropriate.

Referring to FIG. 10, ion-trap 98 is identical in many respects with vacuum pump 10 of FIG. 1. Thus, ion-trap 96 comprises a generally planar doped diamond film 100 which has nanopores, a first conducting layer 102a on doped diamond film 100 (the upper layer in this view), a second conducting layer 102b (the lower layer in this view), opposite first face 102a, on doped diamond film 100, a first electrical connector 104 located on first conducting layer 102a and a second electrical connector (not shown) located on second conducting layer 102b. Unlike vacuum pump 10 of FIG. 1, however, ion-trap 98 has an RF power supply 106, with electrical outputs connected to the first and second electrical connectors respectively and hence to first face 102a and second face 102b respectively.

As with most existing mass spectrometers, the construction of a miniature ion-trap involves compromises in RF voltage and frequency. Ideally low voltages and frequencies would be employed, to keep power requirements as low as possible. However, this decreases trapping efficiency. According to the present embodiment, this limitation in trapping capacity is ameliorated by employing a large array of these nano-scale ion traps. Using this approach, RF power supply 106 of this embodiment can be operated in a frequency range of <1 MHz to about 100 MHz. and voltages from 30 V peak to peak to 300 V peak to peak.

FIGS. 11A and 11B are respectively a schematic cross-sectional detail view 110 of ion-trap 98 according to this embodiment (not to scale) and a schematic plot 112 of dopant concentration p (in this example, boron) as a function of distance d across doped diamond film 100. FIG. 11A also depicts schematically the nanopores 115 that act as individual nano-scale ion traps. The variation in dopant concentration leads to a structure that is conducting at the centre of the film and resistive either side of this central conductor and these resistive layers are connected to two conducting layers 102a, 102b (such as of Au) deposited on each side of doped diamond film 100 (cf. conducting coating 24 constituting first and second faces 18a, 18b of vacuum pump 10 of FIG. 1).

Thus, when a RF field is applied to the two gold layers 102a, 102b, a potential is imposed on the more conducting centre region 114 by resistive connections across diamond film 104. This central potential region 114 and the RF field act as an ion trap, resulting in each nanopore in doped diamond film 100 acting as a nano-scale ion trap.

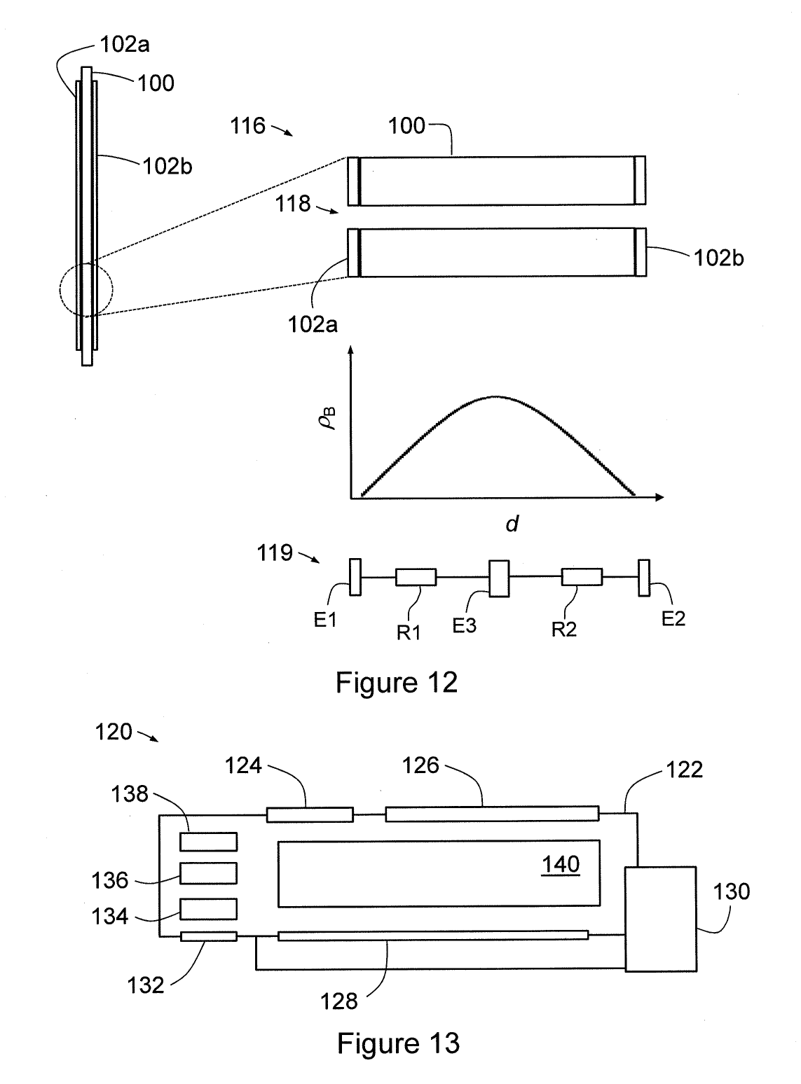

FIG. 12 shows a structural detail and an electrical equivalence circuit of ion trap 98 of FIG. 10. A detail of doped diamond film 100 with metalization in the form of gold layers 102a, 102b is shown in detail at 116 (including an individual nano-scale ion trap 118), below which is depicted schematically the dopant profile (cf. FIG. 11B). In the lowest register of FIG. 12, at 119, is an electrical equivalence circuit corresponding to a transverse plane (in this view) through the metalized, doped diamond film. The electrical equivalent circuit 119 shows that the metalized, doped nanoporous diamond film may be characterized as a three electrode linear ion trap. Thus, conducting layers 102a, 102b act as first and second electrodes E1, E2, while central region 114 acts as a third electrode E3. Relatively insulating regions flanking central region 114 act as resistors R1 and R2 respectively.

It will be appreciated that a scientific instrument comprising one or more of the vacuum pump, ion source and ion-trap of this invention (including variations and other embodiments thereof) may be provided, also according to the present invention. Thus, FIG. 13 is a schematic view of a miniature mass spectrometer 120 according to another embodiment of the present invention.

Miniature mass spectrometer 120 comprises a main housing 122, a display panel 124 and a keypad 126 located on the housing 122, a pumping section comprising a pumping element 128 (comparable to pumping element 12 of FIG. 1) and a diaphragm backing pump 130, a sample entrance film 132, an ion source 134 (comparable to ion source 80 of FIG. 8), an ion trap 136 (comparable to ion-trap 98), a detector film 138 and electronics 140. (Electronics 140 includes the miniature power supplies for the other components.) These components can be manufactured using existing semiconductor processing technology, making spectrometer 120 inexpensive and easy to manufacture.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in any country.

1. A pump, comprising:
a pumping element comprising: a nanoporous insulating film comprising a plurality of nanopores, and first and second conducting layers on first and second opposed sides respectively of said film; and
a power supply configured to maintain a potential difference between said first and second conducting layers that produces a field ionizing electric field;
wherein said pumping element supports a difference in gas pressure on said first and second conducting layers and supports field ionization by the electric field, and said electric field ionizes gas atoms or molecules in a proximity of said first conducting layer, transports said gas atoms or molecules once ionised through said first conducting layer into said nanopores, along said nanopores and through said second conducting layer.

2. A pump as claimed in claim 1, wherein the difference in gas pressure is one atmosphere.

3. A pump as claimed in claim 1, wherein said electric field is approximately 10 MV/cm.

4. A pump as claimed in claim 1, wherein the insulating film comprises a thin nanoporous diamond film or a thin nanoporous silicon nitride film.

5. (canceled)

6. A pump as claimed in claim 1, wherein the first and second conducting layers comprise metallic layers or evaporatively deposited layers metallic layers.

7. (canceled)

8. An element as claimed in claim 1, wherein said first and second conducting layers comprise molybdenum or gold.

9. A pump as claimed in claim 1, wherein the power supply is configured to maintain the first conducting layer at a negative potential relative to the second conducting layer.

10. A pump as claimed in claim 1, wherein the potential difference is relatively low.

11. A pump as claimed in claim 1, wherein the potential of the first conducting layer is −300 to −500 V relative to the second conducting layer.

12. A pump as claimed in claim 1, wherein the pump is adapted to operate with the first conducting layer at a negative potential and the second conducting layer earthed.

13. A vacuum chamber, scientific instrument, mass spectrometer, hand-held mass spectrometer or ion source, comprising a pump as claimed in claim 1.

14-15. (canceled)

16. An ion source, comprising a pump as claimed in claim 1, wherein said power supply is configured to maintain said first conducting layer at a negative voltage of the order of 100s of volts relative to said second conducting layer.

17. A mass spectrometer, comprising an ion source wherein said ion source comprises a pump as claimed in claim 1.

18. An ion trap, comprising:
an ion trap element comprising: a nanoporous insulating film comprising a plurality of nanopores, and first and second conducting layers on first and second opposed sides respectively of said film; and
a RF power supply coupled to said first and second conducting layers to provide a potential difference between said first and second conducting layers;
wherein said nanoporous insulating film is doped so as to have a conducting region between said opposed sides and respective more insulating regions between said conducting region and said respective opposed sides, and a RF field applied to the first and second conducting layers by the RF power supply imposes a potential on the conducting region, whereby the central region and the RF field act as an ion trap.

19. An ion trap as claimed in claim 18, wherein said RF power supply has an operating frequency range between 1 MHz and 100 MHz.

20. An ion trap as claimed in claim 18, wherein said potential difference is between 30 V peak to peak and 300 V peak to peak.

21. A mass spectrometer, comprising an ion trap as claimed in claim 18.

22. A method of pumping or of evacuating a mass spectrometer or other scientific instrument, comprising employing a pump as claimed in claim 1.

23. (canceled)

24. A method of providing ions, comprising employing an ion source that comprises a pump as claimed in claim 1.

25. A method of trapping ions, comprising employing an ion trap as claimed in claim 18.
